(19) United States
(12) Patent Application Publication
(10) Pub. No.: US 2006/0148519 A1
(43) Pub. Date: Jul. 6, 2006

(54) Communication device and method for using speaker as a stud finder

(76) Inventors: Russell L. Simpson, Miami, FL (US); John M. Burgan, North Palm Beach, FL (US); Joseph Patino, Pembroke Pines, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/026,894

(22) Filed: Dec. 30, 2004

(51) Int. Cl. H04Q 7/20

(52) U.S. Cl. 455/556.1

(57) ABSTRACT

A communication device (102) has a loudspeaker (212) that includes a loudspeaker coil. The loudspeaker is used for playing audio signals and for detecting metal in the vicinity of the loudspeaker. To detect metal the communication device includes a pulse generation circuit (216) for generating pulses that are applied to the loudspeaker, and a pulse measurement circuit (222) for measuring response pulses. If the response pulses indicate metal is in proximity to the loudspeaker, an alert is generated to inform the user of the communication device.

### TECHNICAL FIELD

This invention relates in general to communication devices, and more particularly to communication devices that may be used to perform non-communication functions.

### BACKGROUND OF THE INVENTION

Communication devices are in widespread use throughout the world, particularly in metropolitan regions. As the market becomes saturated with these devices, manufacturers have sought to retain markets by increasing the functionality of these devices. One popular hybrid that exemplifies this trend is the so called camera phone. Camera phones are, essentially, a combination of a digital camera integrated into a cellular phone device. A display on the camera phone which ordinarily presents a conventional user interface displays what the camera is aimed at while the camera phone is operated in camera mode.

Certain types of communication devices have become popular in particular industries. For example, in the building construction and contracting industry communication devices with loudspeakers have gained popularity. These communication devices contain a conventional earpiece speaker for holding the communication device close to the user's ear, but also include second speaker for producing sound at a much louder volume than the earpiece speaker so that the sound can be heard when the communication device is held away from the ear, or so that others in the vicinity of the communication device can also hear the sound produced by the loudspeaker, such as, for example, when the communication device is operated as a speakerphone. One particular type of communication device popular in these trades is the kind that supports conventional cellular telephony, and also two-way or walkie-talkie network assisted operation, also known as dispatch calling. Dispatch calling is simplex, where only one person speaks at a time, and generally uses the loudspeaker to play received audio signals. Dispatch calling is often preferred because call setup time is much less than in conventional phone to phone cellular calling. Using dispatch calling a first user may ask a second user a question, and the second user responds in less time than it would take for conventional cellular phone to phone call to be set up and answered.

Given the popularity of these communication devices in the building trades, it is therefore desirable to expand the functionality of these device to include other functions beneficial to those working in such occupations.

### BRIEF DESCRIPTION OF THE DRAWINGS

FIG. 1 shows a system diagram of communication device having a magnetic stud finding functionality, in accordance with one embodiment of the invention;

FIG. 2 shows a block schematic diagram of a communication device in accordance with one embodiment of the invention;

FIG. 3 shows a graph chart diagram of generated pulses and their corresponding response pulses, in accordance with an embodiment of the invention;

FIG. 4 shows a timing diagram for alternating pulses and audible alerts at a loudspeaker in accordance with one embodiment of the invention;

FIG. 5 shows a flow chart diagram of a method of detecting a metallic object with a communication device, in accordance with an embodiment of the invention;

FIG. 6 shows a front view of a communication device in accordance with an embodiment of the invention; and

FIG. 7 shows a back view of a communication device in accordance with an embodiment of the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The invention augments the functionality of a communication device by integrating a magnetic metal detecting ability that may be used to, for example, locate building studs in the wall of a building. The detection of metal is accomplished by generating current pulses through the coil of a loudspeaker of the communication device, and measuring parameters of the response pulse. If the response pulse measurement indicates that metal is in the immediate vicinity of the loudspeaker, the communication device alerts the user of the communication device.

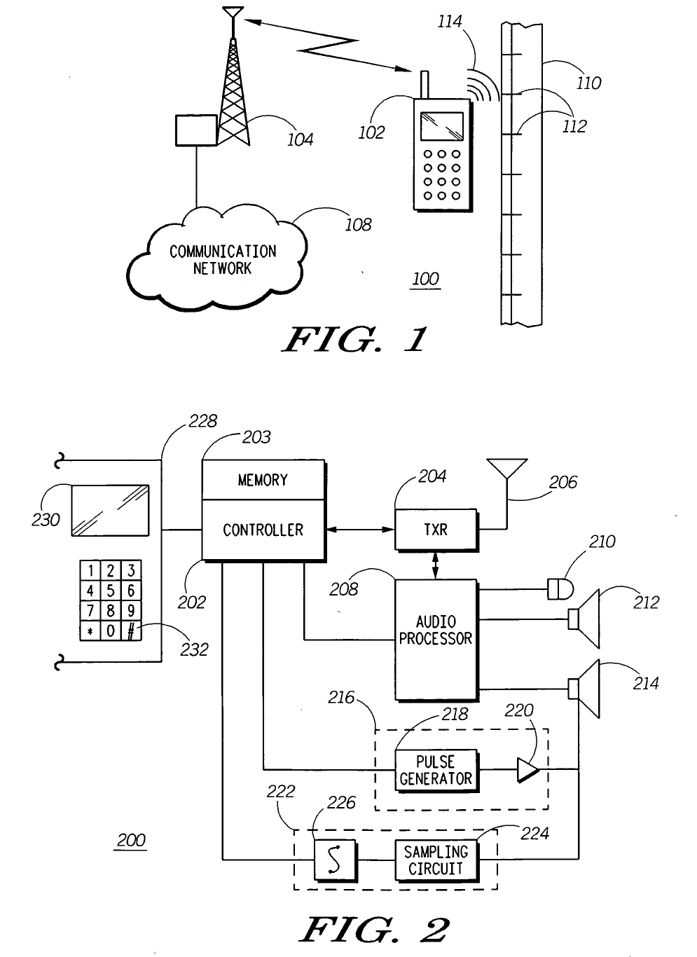

Referring now to FIG. 1, there is shown a system diagram 100 of a communication device 102 having a magnetic stud finding functionality, in accordance with one embodiment of the invention. The communication device 102 communicates with a communication base station 104 over a radio link 106, as may be known in the art. The communication base station 104 is part of a larger communication network 108 which may include other communication base stations as well as infrastructure equipment for establishing calls to other networks such as the public switched telephone network. In addition, the communication device contains a means for detecting metal. One application of having on onboard metal detecting function is that a stud 110 may be found by detecting the present of metal fasteners 112 such as screws and nails used to finish a wall. The communication device generates magnetic pulses 114 which collapse in a known manner when no metal is present in the vicinity of the communication device. The communication device then observes the manner in which the pulse collapses. When metal is present in the in the immediate vicinity of the communication device, changes in the manner in which the pulses collapse may be observed, and the communication device may alert a user that metal has been detected.

Referring now to FIG. 2, there is shown a block schematic diagram 200 of a communication device in accordance with one embodiment of the invention. The communication device contains a controller 202 which controls operation of the communication device in accordance with instruction code in an associated memory 203. The communication device also contains a communication circuit 204, such as a cellular communication circuit or transceiver. The communication circuit 204 is responsible for all modulation, demodulation, mixing, downmixing, amplification, encryption, decryption, and timing of signals received or to be transmitted, as applicable. The communication circuit is coupled to an antenna 206, and establishes a radio link with other communication equipment in accordance with an air interface protocol. Audio signals are processed by an audio processor 208, which is coupled to the communication circuit 204, and controlled by the controller 202. The audio processor is coupled to a microphone 210, earpiece speaker 212, and a loudspeaker 214. The audio processor receives analog signals from the microphone and converts them to digital audio signals, which are passed to the communication circuit for transmission. Similarly, the audio processor receives digital audio signals from the communication circuit that have been received over the radio link, and converts them to analog signals. The received audio signals are played over the earpiece speaker 212 or the loudspeaker 214, as appropriate, depending on the mode. The audio circuit may also have stored audio files, such as ring tones, to be played at the appropriate time, as directed by the controller. The loudspeaker is a magnet and diaphragm type of speaker, having a loudspeaker coil which generates a time varying magnetic field resulting from, and corresponding to an audio signal to be played. Which drives the diaphragm, as is well known in the art.

The communication device further comprises a pulse generator circuit 216 which is operably coupled to the loudspeaker. The pulse generation circuit generates electric current pulses which are applied to the loudspeaker coil. The pulses induce a time varying magnetic field in the immediate vicinity of the loudspeaker coil. The pulse generation circuit may include, for example, a pulse generator 218, coupled to an amplifier 220. The pulse generator 218 generates a voltage or current pulse of a preselected duration, preferably optimized in accordance with the electromagnetic response of the loudspeaker coil. The pulses may be so brief that they do not produce an audible sound at the loudspeaker. As the pulse terminates, and the magnetic field induced by he loudspeaker coil collapses, a voltage will be evident at the terminals of the loudspeaker coil, and will have the reverse polarity of that of the applied pulse. The magnetic feedback produced by the collapsing field produces a response or reflected pulse, which is measured by a feedback sampling circuit 222. The feedback sampling circuit samples the magnetic feedback by measuring, for example, the duration, amplitude, and other electrical parameters of the response pulse. It includes a sampling circuit 224, which may be analog or digital, and filtering or other signal conditioning circuitry 226. In one embodiment of the invention the sampling circuit 224 is an analog to digital converter, and the filtering circuit 226 is an integrator. The integrator produces a value indicative of the amplitude and duration of the response pulse, which may be fed to the controller. When this value rises above a preselected threshold, the controller declares metal to be detected in the immediate vicinity of the loudspeaker coil.

Declaring metal to have been detected can be implemented in numerous ways. It results in the communication device generating an alert to inform the user of the presence of metal in the immediate vicinity of the loudspeaker coil. An audible or visual alert, or both, may be used to inform the user. For example, in one embodiment of the invention, a periodic audible chirp may be generated at the loudspeaker in between pulses applied to the coil. The chirp may be a short sinusoidal waveform having one frequency for when no metal is declared to be detected and a perceptibly different frequency for when metal is detected. The alert may take advantage of a user interface 228 including a display 230 and keypad 232 on the communication device. The display would be placed in such a way that the user of the communication device could see the display when the metal detection mode is used.

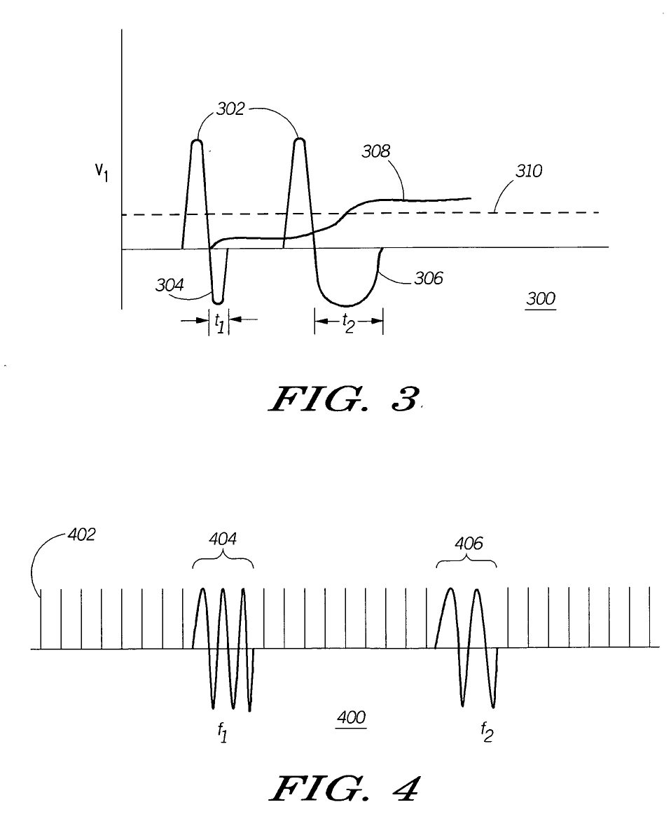

Referring now to FIG. 3, there is shown a graph chart diagram 300 of generated pulses 302 and their corresponding response pulses 304, 306, in accordance with an embodiment of the invention. The generated pulses are generated by the pulse generation circuit 216 and applied to the loudspeaker coil. When the generated pulse terminates, the magnetic field in the loudspeaker coil collapses, resulting in a response or reflected pulse evident at the terminals of the loudspeaker coil which has a voltage polarity that is opposite that of the applied generated pulse. The first response pulse 304 is representative of a response pulse when no metal is present in proximity to the loudspeaker coil. Line 308 shows a tracking level, such as that created by an integrator or integrator function which integrates the response pulse signals. The second response pulse 306 is wider and more energetic, indicating the presence of metal in proximity to the loudspeaker coil. In response, the tracking level 308 rises above a threshold value 310. When the tracking level rises above the threshold value in the present embodiment, the controller declares metal has been detected, and takes the appropriate action to cause the communication device to generate an alert to indicate the detection of metal to the user of the communication device. As an alternative, response pulse width may be measured to determine if metal is detected.

Referring now to FIG. 4, there is shown a timing diagram 400 for alternating pulses and audible alerts at a loudspeaker in accordance with one embodiment of the invention. In the present embodiment, a series of periodic pulses 402 are applied to the loudspeaker coil. Interspersed between pulses are audible signals, such as a first sinusoidal chirp 404 having a first frequency f₁. The first sinusoidal chirp sounds to the user of the communication device like a “beep” at a pitch indicating no metal is detected. The first chirp may be periodically repeated while no metal is detected. When metal is detected, according to the present embodiment, a second sinusoidal chirp 406 is played over the loudspeaker, having a second frequency f₂. The present embodiment therefore allows the user to be informed as the presence of metal, or the lack thereof, by the same element being used to detect the metal, that being the loudspeaker. In addition or alternatively to frequency, the period between chirps may be changed, and similarly the frequency of the chirps may be changed in accordance with the degree to which metal is detected, such as by correlating the chirp frequency with the degree to which the tracking level 308 exceeds the threshold value 310, for example.

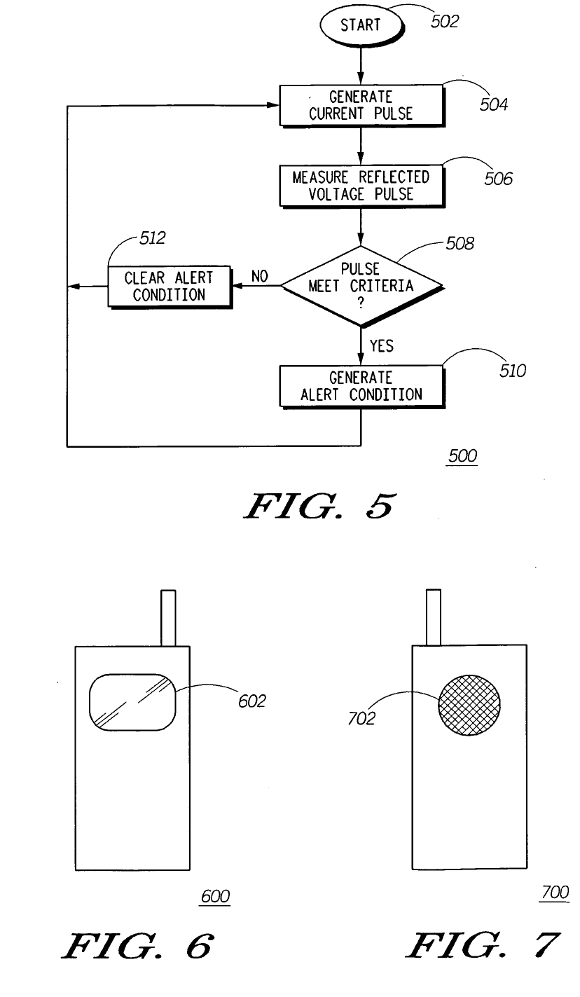

Referring now to FIG. 5, there is shown a flow chart diagram 500 of a method of detecting a metallic object with a communication device, in accordance with an embodiment of the invention. At the start 502 of the method the communication device has been placed in a mode for detecting metal, such as by selecting the metal detection mode from the user interface. Once the metal detection mode has been initiated, the communication device commences generating current pulses through the loudspeaker coil (504). After each pulse, the communication device commences measuring the reflected pulse (506). The communication device then evaluates the reflected pulse (508). If the reflected pulse meets the criteria for declaring metal has been detected, the communication device commences generating an alert condition (510). If the reflected pulse does not indicate metal has been detected, then the alert condition may be cleared (512), if it was previously set.

Referring now to FIGS. 6 and 7, there is shown front and rear views 600, 700, respectively, of a communication device in accordance with one embodiment of the invention. In the configuration of the present embodiment the communication device has a visual display element 602 such as a display on a front of the communication device. The loudspeaker 702 is located on the back of the communication device. This arrangement accomplishes two purposes. First, when used to communicate, the loudspeaker is facing away form the user, so that in case the user places the communication device to the user's ear, as can happen if the user forgets that the loudspeaker mode is active, the user will not have the loud audio directly in the user's ear. Secondly, when used in the metal detection mode, the back of the communication device may be placed against a surface such as a wall, and moved around. If metal is detected, a visual alert may be generated on the display on the front of the communication device.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A communication device, comprising:
a communication circuit for transmitting and receiving radio communication signals;
a loudspeaker having a loudspeaker coil;
an audio circuit coupled to the loudspeaker and the communication circuit, the audio circuit generating audio signals to be played by the loudspeaker, the audio signals being derived from the radio communication signals;
a pulse generator circuit coupled to the loudspeaker for generating magnetic pulses with the loudspeaker coil;
a feedback sampling circuit coupled to the loudspeaker for sampling magnetic feedback at the loudspeaker coil; and
a user interface to indicate when the magnetic feedback at the loudspeaker coil indicates the presence of a metallic object in the vicinity of the loudspeaker.

2. A communication device as defined in claim 1, wherein the loudspeaker is disposed on a back of the communication device, and wherein the user interface includes a visual display element disposed on a front of the communication device.

3. A communication device as defined in claim 1, further comprising an earpiece speaker.

4. A communication device as defined in claim 1, wherein the user interface provides an audible indication of the presence of the metallic object in the vicinity of the loudspeaker.

5. A communication device as defined in claim 1, wherein the user interface provides a visual indication of the presence of the metallic object in the vicinity of the loudspeaker.

6. A method of detecting the presence of a metallic object in the vicinity of a communication device, comprising:
applying an electric current pulse to a loudspeaker coil of a loudspeaker of the communication device;
measuring a reflected pulse observed at the loudspeaker coil in response to applying the electric current pulse; and
generating an alert if the reflected pulse is indicative of the presence of metal in the vicinity of the loudspeaker coil.

7. A method of detecting the presence of a metallic object as defined in claim 6, wherein applying the electric current pulse comprises applying a plurality of periodically occurring electric current pulses, thereby inducing a plurality of corresponding reflected pulses.

8. A method of detecting the presence of a metallic object as defined in claim 7, wherein measuring the reflected pulse comprises integrating a plurality of the reflected pulses to produce a voltage level.

9. A method of detecting the presence of a metallic object as defined in claim 8, wherein generating the alert comprises generating the alert if the voltage level rises above a preselected threshold level.

10. A method of detecting the presence of a metallic object as defined in claim 6, wherein generating the alert comprises performing at least one of generating an audible alert and generating a visual alert.

11. A cellular phone device, comprising:
a cellular phone communication circuit for transmitting and receiving radio communication signals;
a loudspeaker having a loudspeaker coil;
an audio circuit coupled to the loudspeaker and the communication circuit, the audio circuit generating audio signals to be played by the loudspeaker, the audio signals being derived from the radio communication signals;
a pulse generator circuit coupled to the loudspeaker for generating magnetic pulses with the loudspeaker coil;
a feedback sampling circuit coupled to the loudspeaker for sampling magnetic feedback at the loudspeaker coil; and
a user interface to indicate when the magnetic feedback at the loudspeaker coil indicates the presence of a metallic object in the vicinity of the loudspeaker.

12. A cellular phone device as defined in claim 11, wherein the loudspeaker is disposed on a back of the communication device, and wherein the user interface includes a visual display element disposed on a front of the communication device.

13. A cellular phone device as defined in claim 11, further comprising an earpiece speaker.

14. A cellular phone device as defined in claim 11, wherein the user interface provides an audible indication of the presence of the metallic object in the vicinity of the loudspeaker.

15. A cellular phone device as defined in claim 11, wherein the user interface provides a visual indication of the presence of the metallic object in the vicinity of the loudspeaker.
